(19) United States
(12) Patent Application Publication
(10) Pub. No.: US 2010/0260435 A1
(43) Pub. Date: Oct. 14, 2010

(54) Edge Directed Image Processing

(76) Inventor: Christopher J. Orlick, Washington Crossing, PA (US)

Correspondence Address: HICKMAN PALERMO TRUONG & BECKER, LLP, 2055 GATEWAY PLACE, SUITE 550, SAN JOSE, CA, 95110, US

(21) Appl. No.: 12/809,453

(22) PCT Filed: Dec. 17, 2008
(86) PCT No.: PCT/US08/87179

§ 371 Date: Jun. 18, 2010

Related U.S. Application Data
(62) Division of application No. 61/098,111, filed on Sep. 18, 2008.
Application No. 61/098,111 is a division of application No. 61/016,371, filed on Dec. 21, 2007.

(51) Int. Cl. G06K 9/40

(52) U.S. Cl. 382/266

(57) ABSTRACT

Information is accessed, which relates to an edge feature of an input video image at an input resolution value. The information relates multiple input image pixels to the edge feature, which has a profile characteristic. The information includes, for input pixels that form a component of the edge feature, an angle value corresponding thereto. An output image is registered, at an output resolution value, to the input image. Based on the registration, the edge feature related information is associated with output pixels. The associated information designates at least some of the output pixels as registered with the input image edge feature and the corresponding edge angle value. Edge component input pixels are selected based on the edge angle value. The selected edge component input pixels are processed, which deters deterioration of the profile characteristic of the edge feature in the output image.

### TECHNOLOGY

The present invention relates generally to video processing. More specifically, embodiments of the present invention relate to edge directed image processing.

### BACKGROUND

Video images may have a variety of image features. For instance, a video image may have one or more edge features. As used herein, the terms “edge” and/or “edge feature” may refer to an image feature that characterizes a visible distinction, such as a border, between at least two other image features.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF SUMMARY OF SOME ASPECTS OF AN EXAMPLE EMBODIMENT

The following paragraph presents a brief, simplified summary for providing a basic understanding of some aspects of an embodiment of the present invention. It should be noted that this summary is not an extensive overview of aspects of the embodiment. Moreover, it should be noted that this summary is not intended to be understood as identifying any particularly significant aspects or elements of the embodiment, nor as delineating any scope of the embodiment in particular, nor the invention in general. The following brief summary merely presents some concepts that relate to the example embodiment in a condensed and simplified format, and should be understood as merely a conceptual prelude to a more detailed description of example embodiments that follows this brief summary.

An example embodiment processes video images. Information is accessed, which relates to an edge feature of an input video image. The input image has an input resolution value. The accessed information relates multiple pixels of the input image to the input image edge feature. The information includes, for input pixels that form a component of the edge feature, an angle value that corresponds to the edge feature. The edge feature has a profile characteristic in the input image. The profile characteristic may describe or define shape, sharpness, contour, definition and/or other attributes of the edge.

An output image is registered, at an output resolution value, to the input image. Based on the registration, the accessed edge feature related information is associated with output pixels. The associated information designates at least some of the output pixels as registered with the input image edge feature and the corresponding edge angle value. Edge component input pixels are selected based on the edge angle value. The selected edge component input pixels are processed. Processing the edge component input pixels deters deterioration of the profile characteristic of the edge feature in the output image. The output image resolution may equal or differ from the input image resolution.

A noise reduction operation may be performed based on the processing. In performing noise reduction, the output resolution and the input resolution may be equal and, processing the selected edge component input pixels step may include filtering of the selected edge component input pixels with a low pass filter.

Where the output and input resolutions differ, the output resolution may be greater or less than the input resolution and, processing the selected edge component input pixels may include interpolating, e.g., applying interpolation filtering to, the selected edge component input pixels. An output pixel may be generated based on the interpolation filtering that is applied to the generated pixels. Processing the selected edge component input pixels step may include performing interpolation filtering on one or more groups of the selected edge component input pixels. The interpolation filtering performed may generate pixels at locations in the output image that conform to the edge angle value. Interpolation filtering may then be applied to the generated pixels. An output pixel may then be generated based on the interpolation filtering applied to the generated pixels. Processing the video image may include performing a scaling operation, such as upconversion and/or downconversion on the video image based on the filtering process.

Processing the selected edge component input pixels, in accordance with an embodiment, does not require a scaling procedure, such as horizontal and/or vertical filtering. Such scaling however may be used with an embodiment, for input pixels that are free of an edge feature (e.g., pixels that do not lie on an edge or form a component of an edge feature).

Embodiments of the present invention could also be applied to a variety of formats and interleaving mechanisms. For example, those used currently for the compression and delivery of three dimensional (3D) content. This can include row interleaved (field sequential), bottom under, checkerboard, pixel/column interleaved, and side by side, among others.

One or more embodiments of the present invention may relate to such a procedure or process, and/or to systems in which the procedures and process may execute, as well as to computer readable storage media, such as may have encoded instructions which, when executed by one or more processors, cause the one or more processors to execute the process or procedure.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 depicts an example input image with an edge feature, according to an embodiment of the present invention;

FIGS. 2A and 2B respectively depict a portion of the edge feature and an example map of the edge feature, according to an embodiment of the present invention;

FIGS. 3A and 3B respectively depict the example edge map and a grid at resolution other than the input image, and the example edge map at the other resolution, according to an embodiment of the present invention;

FIG. 4 depicts an example superimposition operation, according to an embodiment of the present invention;

FIG. 5 depicts an example shift operation based on an edge angle, according to an embodiment of the present invention;

FIG. 6 depicts the retrieval of pixels centered about the edge angle, according to an embodiment of the present invention;

FIGS. 7A and 7B respectively depict an example shift based on the edge angle with a non-centric pixel, and the retrieval of pixels centered about the edge angle with a non-centric pixel, according to an embodiment of the present invention;

FIG. 8 depicts an example output pixel positioning, according to an embodiment of the present invention;

FIG. 9 depicts a flowchart for an example procedure, according to an embodiment of the present invention; and

FIG. 10 depicts an example computer system platform, with which an embodiment of the present invention may be implemented.

### DESCRIPTION OF EXAMPLE EMBODIMENTS

Embodiments relating to edge directed image processing are described herein. In the following description, for the purposes of explanation, numerous specific details are set forth in order to provide a thorough understanding of the present invention. It will be apparent, however, that the present invention may be practiced without these specific details. In other instances, well-known structures and devices are not described in exhaustive detail, in order to avoid unnecessarily occluding, obscuring, or obfuscating the present invention.

### Overview

Example embodiments described herein relate to edge directed image processing. In processing video images, information is accessed, which relates to an edge feature of an input video image. The input image has an input resolution value. The accessed information relates multiple pixels of the input image to the input image edge feature. The information includes, for input pixels that form a component of the edge feature, an angle value that corresponds to the edge feature. The edge feature has a profile characteristic in the input image. The profile characteristic may describe or define shape, sharpness, contour, definition and/or other attributes of the edge.

An output image is registered, at an output resolution value, to the input image. Based on the registration, the accessed edge feature related information is associated with output pixels. The associated information designates at least some of the output pixels as registered with the input image edge feature and the corresponding edge angle value. Edge component input pixels are selected based on the edge angle value. The selected edge component input pixels are processed. Processing the edge component input pixels deters deterioration of the profile characteristic of the edge feature in the output image. The output image resolution may equal or differ from the input image resolution.

Edge directed image processing utilizes detected edges in video images and allows efficient image re-sampling. Embodiments may thus be used for scaling and/or motion compensated video processing applications. Embodiments efficiently re-sample video images without significant effects related to aliasing maintenance or enhancement effects and without significant bandwidth constraints. Moreover, embodiments function to provide efficient video image re-sampling without causing significant ringing effects in interpolation filters.

The output image resolution may equal or differ from the input image resolution. For some noise reduction applications for instance, the output image resolution may not vary significantly or may equal the input image resolution. An example embodiment is explained herein with reference to an implementation in which the output image is at a higher resolution that the input image, which may be used in scaling applications such as upconversion. For example, an embodiment functions to generate a high definition television (HDTV) output image from a video input at a relatively lower resolution standard definition. However, it should be appreciated by artisans skilled in fields that relate to video processing, video compression and the like that the example implementations described herein are selected for purposes of illustration and not limitation.

Embodiments of the present invention relate to two dimensional (2D) imaging applications, as well as to three dimensional (3D) applications (the terms 2D and 3D in the present context refer to spatial dimensions). Moreover, embodiments relate to computer imaging and medical imaging applications, as well as other somewhat more specialized image processing applications, such as 2D and/or 3D bio-medical imaging. Bio-medical imaging uses may include nuclear magnetic resonance imaging (MRI), and echocardiography, which can, for example, visually render motion images of a beating heart in real time for diagnosis or study. 3D imaging applications may visually render translational motion, e.g., associated with the beating of the heart, in a 3D image space that includes a “depth” or “z” component.

Example embodiments are described herein with reference to 2D video sequences. It should be apparent however from the description that embodiments are not limited to these example features, which are used herein solely for uniformity, brevity, simplicity and clarity. On the contrary; it should be apparent from the description that embodiments are well suited to function with 3D and various multi-dimensional applications, and with imaging applications such as computer imaging and bio-medical imaging. In the present context, the terms 2D and 3D refer to spatial dimensions.

Embodiments of the present invention could also be applied to a variety of formats and interleaving mechanisms. For example, those used currently for the compression and delivery of 3D content. This can include row interleaved (field sequential), bottom under, checkerboard, pixel/column interleaved, and side by side, among others.

An embodiment functions to initially detect edge features and determine an angle associated with the edge feature in a video image at the resolution of the source video, e.g., the input resolution. For applications in which the output resolution is greater than the input resolution, performing initial edge feature detection and edge angle determination at the lower input resolution (e.g., rather than at the potentially higher output resolution) may economize on computational resources used in such processing. Additionally, for applications such as motion compensated processing, edge results may be calculated and buffered for each incoming frame. Calculating and buffering edge results for each incoming video frame may be utilized to create a multiplicity of output pixels for use.

A computer system may perform one or more features described herein. The computer system includes one or more processors and may function with hardware, software, firmware and/or any combination thereof to execute one or more of the features described above. The processor(s) and/or other components of the computer system may function, in executing one or more of the features described above, under the direction of computer-readable and executable instructions, which may be encoded in one or multiple computer-readable storage media and/or received by the computer system.

One or more of the features described herein may execute in an encoder or decoder, which may include hardware, software, firmware and/or any combination thereof, which functions on a computer platform. The features described herein may also execute in components, circuit boards such as video cards, logic devices, and/or an integrated circuit (IC), such as a microcontroller, a field programmable gate array (FPGA), an application specific IC (ASIC), and other platforms.

### Example Edge Directed Image Processing Technique

The location and angles are determined for one or more edge features in an input image video image at (e.g., having) an input resolution. Edge features (e.g., edges) may be detected and their edge angles determined by a variety of techniques. One example technique for finding edges and determining angles processes both interlaced and progressive images of any resolution and aspect ratio.

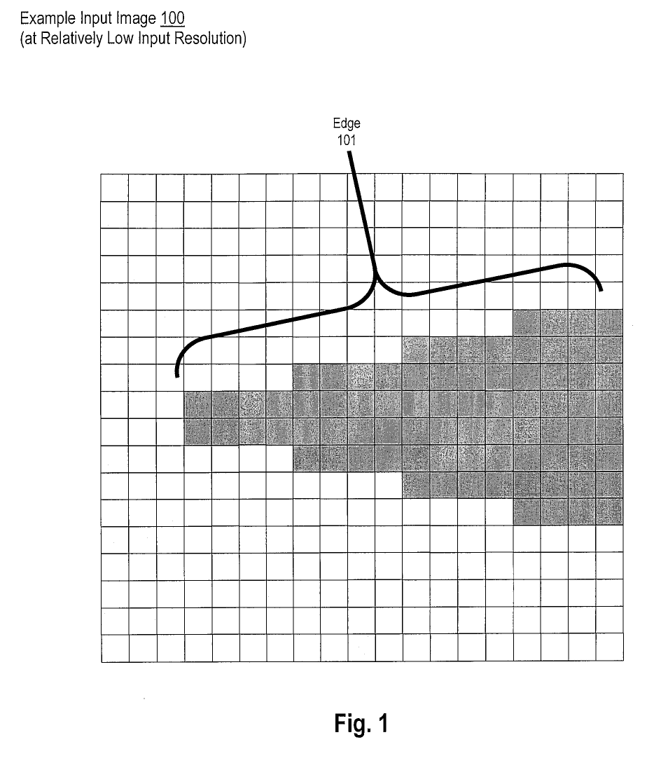

FIG. 1 depicts an example input image 100, according to an embodiment of the present invention. Input image 100 has an edge feature (e.g., an edge) 101. Input image 100 is shown as a simple progressive source image with a darkened image feature that resembles a segment of a “diamond” like shape against a lighter background. Edge feature 101 corresponds to a boundary at the top of the diamond shape segment, e.g., where in the image that the diamond shape segment ends and that the lighter background begins. Each square shaped segment within input image 100 corresponds to a single input pixel.

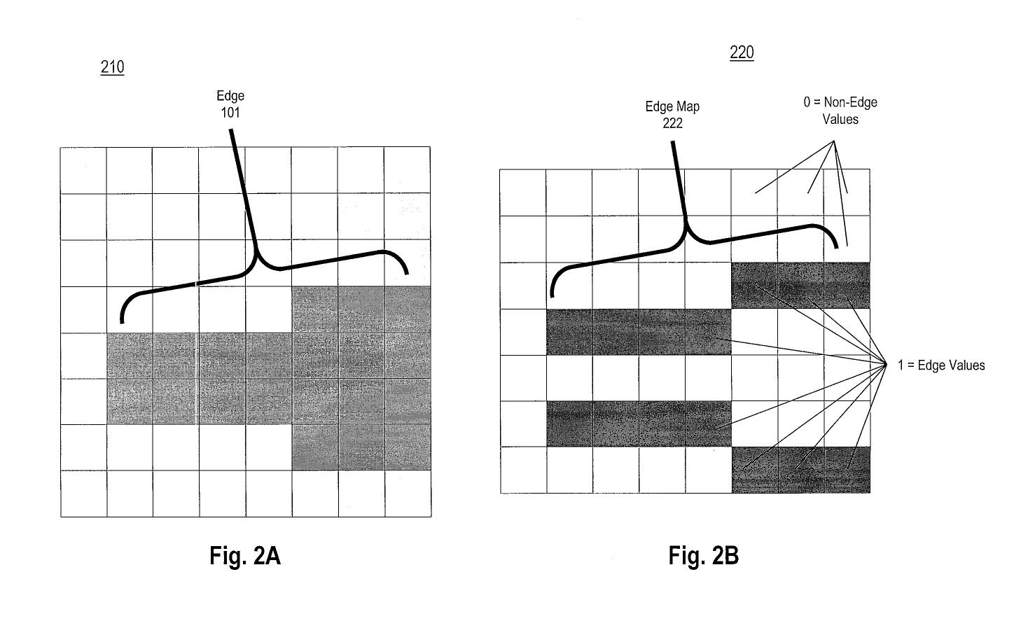

Determining the location and angle of the edge feature may result in a map, which has the same resolution as the original image. FIG. 2A depicts a portion 210 of the edge feature 101. The edge detection and angle determination techniques employed may create a map with the edge values centered on a grid between original input pixels (e.g., in horizontal and/or vertical directions or orientations) or centered on a grid with any relation to the original input pixels. FIG. 2B depicts an example map 222 of the edge feature, according to an embodiment of the present invention. Grid 220 is overlaid upon image portion 210 for mapping edge features associated therewith.

Section 210 of the original input image 100 is essentially zoomed, and the edge detection output shown as edge map 222. Depicted as dark squares, the edge values of ‘1’ indicates locations in section 210 where edges were found, e.g., input pixels that are components of the edge feature in input image 100. Depicted as lighter squares, non-edge values ‘0’ indicate locations in section 210 at which no edge component pixels are found. In addition to indicating “edge/no-edge” locations, each ‘1’ value edge feature location in map 222 contains an angle (e.g., edge angle) that is associated with the edge feature 101.

In an embodiment, the output resolution of an output image may be equal to the input resolution. This may be useful in video noise reduction applications. However, in an embodiment, the output resolution of an output image may differ from the input resolution. This may be useful in video scaling applications, such as downconversion and upconversion. The output resolution may thus be less than the input resolution or, as shown in the figures that depict the example implementation described herein, the output resolution may exceed the input resolution.

Image re-sampling may be performed to create an output with resolution greater (or less) than the original input image resolution in the horizontal and/or the vertical orientations. Re-sampling calculations may process each output pixel individually, as the relationship between the input and output samples may change for every output location. To allow edge directed processing, each output location is registered to the angle map to determine if the output pixel is located in the area of an edge in the original image.

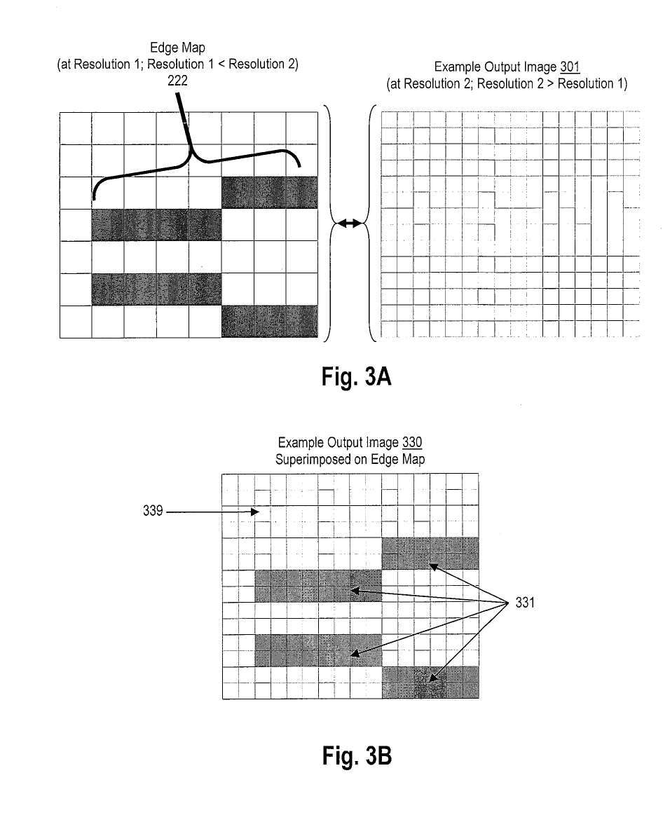

FIG. 3A depicts example edge map 222 at its original input image resolution and a higher resolution output grid 322, according to an embodiment of the present invention. Grid 322 is shown at twice the horizontal and vertical resolution of the original input image edge map 222. FIG. 3B depicts a composite 330 of the higher resolution output grid 322 superimposed on (e.g., registered to) the edge map 222. This “high resolution” edge map provides per-pixel edge information, with which an output image may be calculated. For instance, the output pixels 331 are located in areas of edges in the original input image. An output image may be calculated using edge directed processing, according to an embodiment, for output pixels 331 located in edge areas. Horizontal and/or vertical filtering or other upscaling techniques may be used to calculate an output image with output pixels 339, which are not edge feature component output pixels.

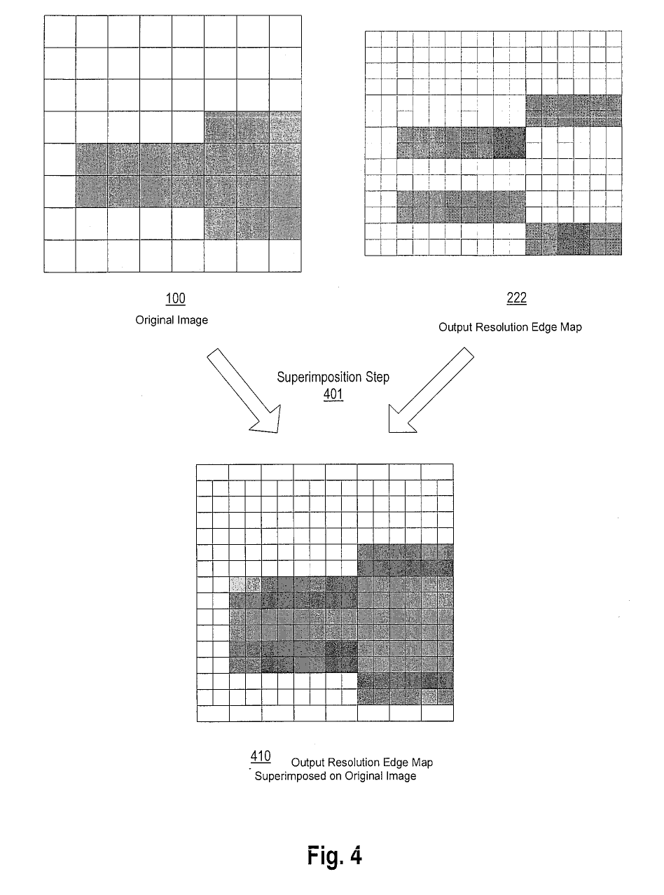

FIG. 4 depicts an example registration (e.g., “superimposition”) operation 401, according to an embodiment of the present invention. The output resolution edge map 222 is superimposed on the original input 100 to compute an output resolution edge map superimposed edge map 410. Edge map 410 illustrates a relationship that may exist between the edge map data and the original image.

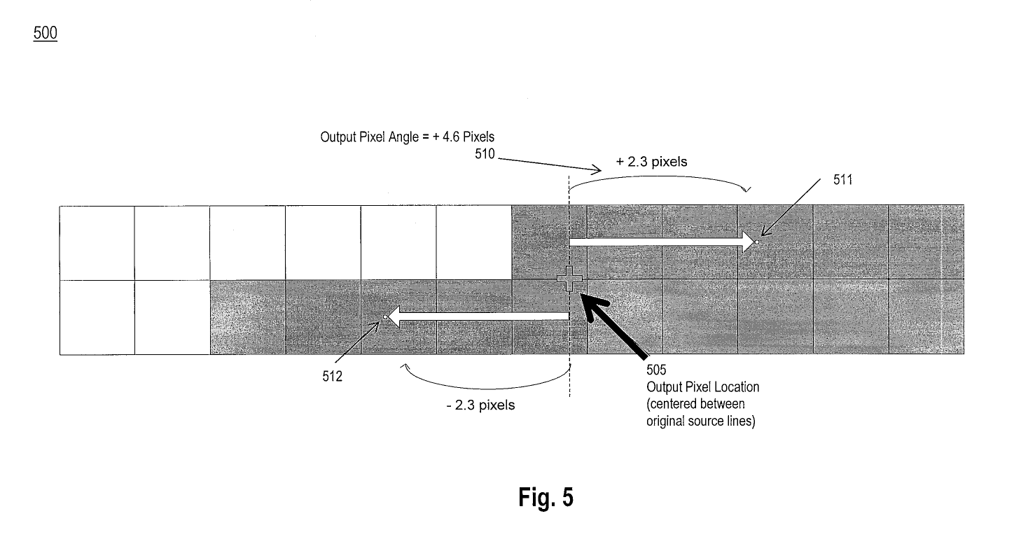

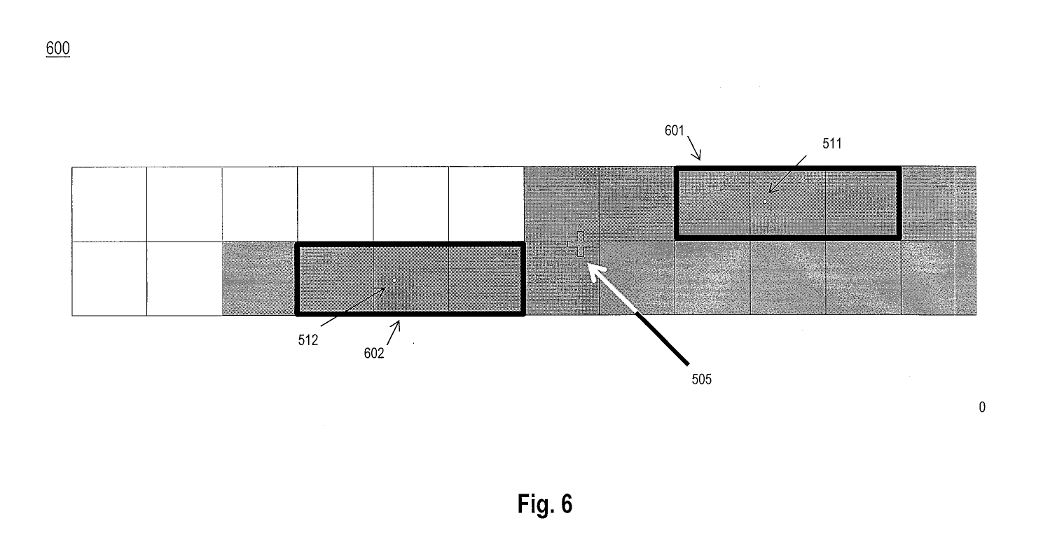

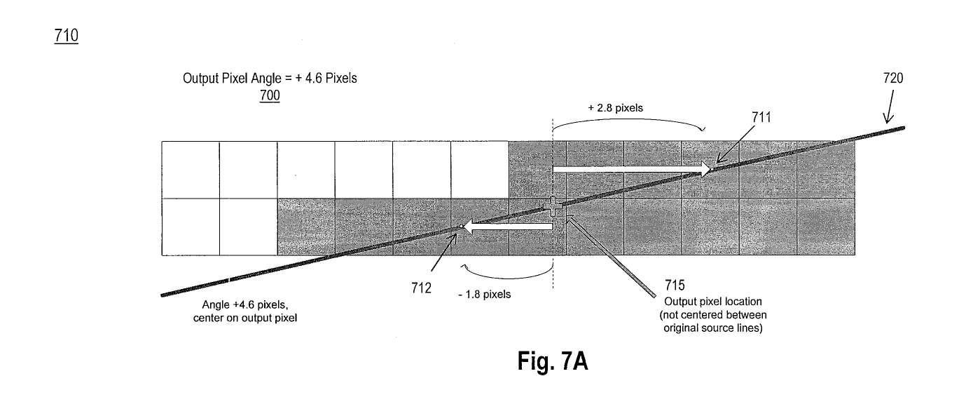

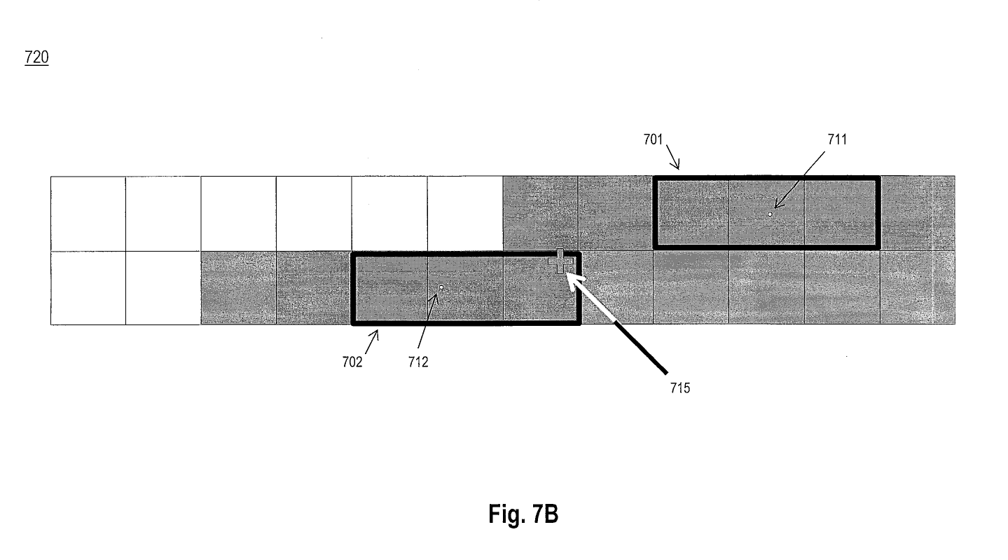

For each output pixel that has an associated edge, original input pixels are retrieved, as described by the edge angle. Where the edge angles conform to a relatively shallow angle, e.g., with respect to a slope associated therewith, or slope relatively gradually or linger somewhat proximately with respect to horizontal (e.g., as depicted in FIG. 5, FIG. 6, FIG. 7A and/or FIG. 7B), the original input pixels may be retrieved from input lines above and below the output pixel position. Where the edge angles conform to a relatively steeper angle, e.g., with respect to a slope associated therewith, or slope relatively rapidly with respect to horizontal or approaching vertically, the original input pixels may be retrieved from input lines that are adjacent to (e.g., to the left and right of) the output pixel position. With either shallow or steep angles, original pixels are selected in an embodiment based on the offset of the edge angle. Embodiments are thus well suited to function over edge angles of virtually any slope.

In the examples depicted and described herein, for each output pixel that has an associated edge, original pixels from the lines above and below the edge location are retrieved, offset by the edge angle. An output pixel that has an associated edge may be an output pixel that is a component of the edge feature in the input and/or output image. In an embodiment, edge angles are stored in pixel units (e.g., rather than in degrees, radians, or other angular measurement units). Storing edge angles in pixel units allows the edge angles to be used as direct offsets on the original input pixel grid. Edge angles may be stored with sub-pixel accuracy.

Processing original input image 100 illustrates an example. The edge “steps” in input image 100 are depicted graphically as having an edge angle of approximately four (4), e.g., the edges in input image 100 translates four (4) pixels horizontally for each pixel vertically. For an image such as a binary test image, an edge angle may exactly equal four (4), but other edge angles may be expected with some video images. For example, a grayscale image may have an edge angle of 4.6. For an output position midway between the input pixels, pixels may be retrieved from the lines above and below, directly using one-half the edge angle, e.g. 2.3.

FIG. 5 depicts an example shifting operation, based on an edge angle 510, according to an embodiment of the present invention. The shifting operation processes retrieved pixels of the input image to generate values located at positions along the edge. Interpolation filters may be used in the shifting operation, generating values along the edge for the input lines above and below the output pixel. These values may then be processed to generate the output pixel. FIG. 5 illustrates a simple example with an output pixel that is located midway between the upper and lower original input lines, such as may occur for half the lines in a times-two (2×) vertical upscaling. Where the edge angle for a particular output pixel is +4.6, pixels from the line above are retrieved which are centered at +2.3 pixels to the right of the output location, (position 511), and pixels from the line below are retrieved which are centered −2.3 pixels to the left of the output location (position 512).

FIG. 6 depicts the retrieval of pixels centered about the edge angle. Locations 511 and 512 indicate the intersection of the edge angle with the lines above and below the output pixel, and regions 601 and 602 depict a group of pixels centered about these locations. Any number of pixels may be grouped about locations 511 and 512. An embodiment may function with three pixels for use with the interpolation filter. However, fewer or more pixels may be used to achieve effective interpolation filtering in a particular application. Retrieved pixels from the line above, group 601, may be interpolated to generate a value that is along the line described by the edge angle, e.g., generate a value along the edge. Similarly, pixels from the line below, group 602, may be interpolated to compute a value that is along the line described by the edge angle, i.e., generate a value along the edge. The interpolated values for the lines above and below may then be processed to determine the output pixel at location 505.

Output pixels that are located midway between original lines may be useful in certain circumstances or applications. For generic scaling applications, output pixels may be located anywhere. Edge angle based processing alone may not suffice to determine which pixels from the lines above and below to retrieve for output pixels that are not edge components. Horizontal and vertical filtering may be used for output pixels that are not edge components.

An arbitrary scale relationship may exist between the input and output grids. A different output image with a different resolution, with the same edge angle of +4.6 pixels, may result in output pixel positions that are not located midway vertically between input lines. This results in a different intersection of the angle with the original pixels on the lines above and below.

FIG. 7A depicts an example shift 710 based on the edge angle with non-centric pixel 715, according to an embodiment of the present invention. Locations 711 and 712 indicate the intersection of the edge angle with the lines above and below the output pixel. The line 720 depicts the edge angle drawn through the output pixel location 715.

FIG. 7B depicts the retrieval of pixels centered about the edge angle. Centered about locations 711 and 712, pixels are retrieved from the lines above and below the output pixel, and regions 701 and 702 depict a group of pixels centered about these locations. An embodiment may function with three pixels for use with the interpolation filter. However, fewer or more pixels may be used to achieve effective interpolation filtering in a particular application.

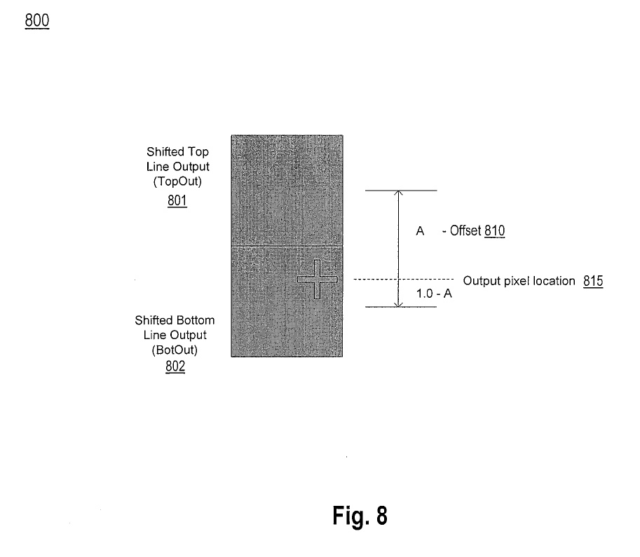

FIG. 8 depicts an example filtering operation 800, according to an embodiment of the present invention. This operation combines the interpolated output from the lines above and below the output pixel. To combine the top line interpolated (or shifted) output 801 and the bottom line interpolated (or shifted) output, the vertical offset of the output pixel 815 may be calculated relative to the input image. The vertical offset between the center of the original input samples determines a weighting for the top shifted sample 801 and the bottom shifted sample 802. Weighted averaging may be used, as may be a more complex blending of the top and bottom samples.

The output pixel location 815 (OPL) is computed with the shifted top line output 801 (TopOut), the shifted bottom line output 802 (BotOut), and the offset 810 ‘A’, according to Equation 1, below.

OPL=(TopOut)(1.0−A)+(BotOut)(A) (Equation 1.)

Output pixels that are not located in areas where edges were detected in the original image may be processed with horizontal and vertical interpolation filtering.

Edge directed image processing according to embodiments may be used in applications that include (but are not limited to), edge-directed scaling, and motion compensated processing.

Scaling applications may be performed with an embodiment. In a scaling application, each output pixel has a unique combination of horizontal and vertical displacement relative to the input image. This allows edge detection processing to proceed at the source resolution rather than the output resolution. Thus, higher output resolutions do not incur greater processing for the initial stages.

Motion compensated processing systems may also utilize edge directed processing, e.g., as an extension of another scaling application. In motion compensated processing, multiple neighboring frames may be used to predict each output pixel. Pixels from neighboring frames may be shifted horizontally and vertically as prescribed by the motion estimates between frames to provide temporally predicted versions of the output. The motion-based shifting may include retrieving a block of pixels displaced by the motion, followed by horizontal and vertical interpolation filters to achieve sub-pixel accuracy. Where edge and angle processing precedes this step however, higher quality edge directed outputs may be created, in contrast to horizontal and vertical filter outputs, which may yield higher quality temporal predictors.

Edge detection and angle determination can be performed once on each incoming frame, at the lower original source resolution, and buffered, which may reduce a need for these calculations to be performed each time an output is required.

### Example Procedure

The example procedures described herein may be performed in relation to edge directed image processing. Procedures that may be implemented with an embodiment may be performed with more or less steps than the example steps shown and/or with steps executing in an order that may differ from that of the example procedures. The example procedures may execute on one or more computer systems, e.g., under the control of machine readable instructions encoded in one or more computer readable storage media, or the procedure may execute in an ASIC or programmable IC device.

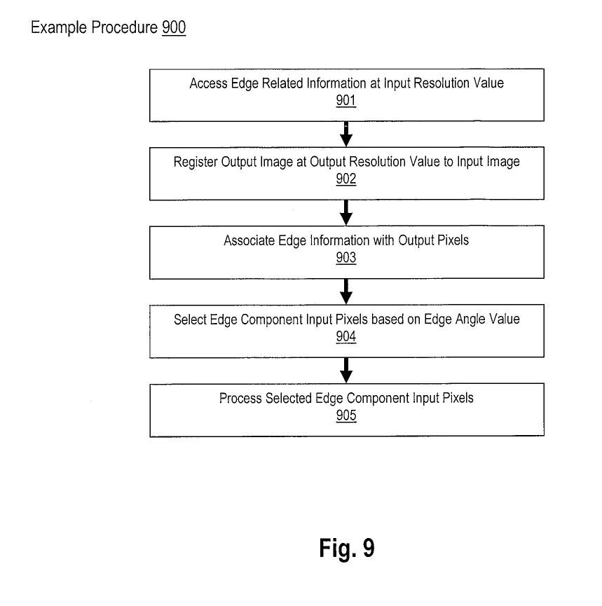

An example embodiment processes video images. FIG. 9 depicts a flowchart for an example procedure 900, according to an embodiment of the present invention. In step 901, information is accessed, which relates to an edge feature of an input video image. The input image has an input resolution value. The accessed information relates a multiple pixels of the input image to the input image edge feature. The information includes, for input pixels that form a component of the edge feature, an angle value that corresponds to the edge feature. The edge feature has a profile characteristic in the input image. The profile characteristic may describe or define shape, sharpness, contour, definition and/or other attributes of the edge.

In step 902, an output image is registered, at an output resolution value, to the input image. Based on the registration in step 903, the accessed edge feature related information is associated with output pixels. The associated information designates at least some of the output pixels as registered with the input image edge feature and the corresponding edge angle value. In step 904, edge component input pixels are selected based on the edge angle value. In step 905, the selected edge component input pixels are processed. Processing the edge component input pixels deters deterioration of the profile characteristic of the edge feature in the output image. The output image resolution may equal or differ from the input image resolution.

A noise reduction operation may be performed based on the processing. In performing noise reduction, the output resolution and the input resolution may be equal and, processing the selected edge component input pixels step may include filtering of the selected edge component input pixels with a low pass filter.

Where the output and input resolutions differ, the output resolution may be greater or less than the input resolution and, processing the selected edge component input pixels may include interpolating, e.g., applying interpolation filtering to, the selected edge component input pixels. An output pixel may be generated based on the interpolation filtering that is applied to the generated pixels. Processing the selected edge component input pixels step may include performing interpolation filtering on one or more groups of the selected edge component input pixels. The interpolation filtering performed may generate pixels at locations in the output image that conform to the edge angle value. Interpolation filtering may then be applied to the generated pixels. An output pixel may then be generated based on the interpolation filtering applied to the generated pixels. Processing the video image may include performing a scaling operation, such as upconversion and/or downconversion on the video image based on the filtering process.

Processing the selected edge component input pixels, in accordance with an embodiment, does not require a scaling procedure, such as horizontal and/or vertical filtering. Such scaling however may be used with an embodiment, for input pixels that are free of an edge feature (e.g., pixels that do not lie on an edge or form a component of an edge feature).

### Example Computer System Platform

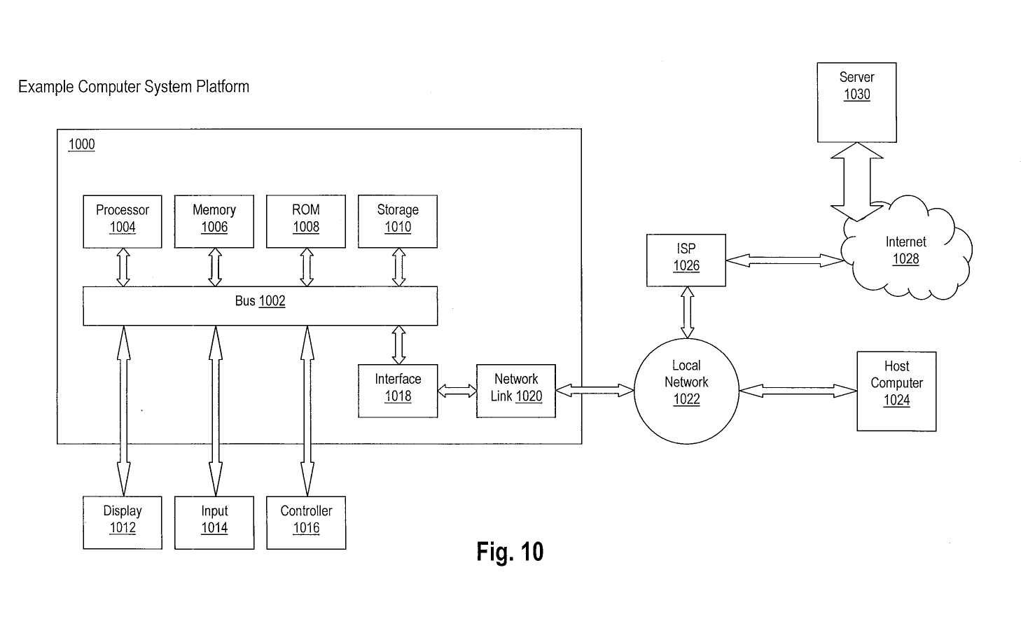

FIG. 10 depicts an example computer system platform 1000, with which an embodiment of the present invention may be implemented. Computer system 1000 includes a bus 1002 or other communication mechanism for communicating information, and a processor 1004 (which may represent one or more processors) coupled with bus 1002 for processing information. Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Computer system 1000 further includes a read only memory (ROM) 1008 or other static storage device coupled to bus 1002 for storing static information and instructions for processor 1004. A storage device 1010, such as a magnetic disk or optical disk, is provided and coupled to bus 1002 for storing information and instructions.

Computer system 1000 may be coupled via bus 1002 to a display 1012, such as a liquid crystal display (LCD), cathode ray tube (CRT) or the like, for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

The invention is related to the use of computer system 1000 for edge directed image processing. According to one embodiment of the invention, edge directed image processing is provided by computer system 1000 in response to processor 1004 executing one or more sequences of one or more instructions contained in main memory 1006. Such instructions may be read into main memory 1006 from another computer-readable medium, such as storage device 1010. Execution of the sequences of instructions contained in main memory 1006 causes processor 1004 to perform the process steps described herein. One or more processors in a multi-processing arrangement may also be employed to execute the sequences of instructions contained in main memory 1006. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 1004 for execution. Such a medium may take many forms, including but not limited to, non-volatile media, volatile media, and transmission media. Non-volatile media includes, for example, optical or magnetic disks, such as storage device 1010. Volatile media includes dynamic memory, such as main memory 1006. Transmission media includes coaxial cables, copper wire and other conductors and fiber optics, including the wires that comprise bus 1002. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other legacy or other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 1004 for execution. For example, the instructions may initially be carried on a magnetic disk of a remote computer. The remote computer can load the instructions into its dynamic memory and send the instructions over a telephone line using a modem. A modem local to computer system 1000 can receive the data on the telephone line and use an infrared transmitter to convert the data to an infrared signal. An infrared detector coupled to bus 1002 can receive the data carried in the infrared signal and place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card or a digital subscriber line (DSL), cable or other modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the worldwide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of carrier waves transporting the information.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018. In accordance with the invention, one such downloaded application provides for edge directed image processing, as described herein.

The received code may be executed by processor 1004 as it is received, and/or stored in storage device 1010, or other non-volatile storage for later execution. In this manner, computer system 1000 may obtain application code in the form of a carrier wave.

Computer system 1000 may be a platform for, or be disposed with or deployed as a component of an electronic device or apparatus. Devices and apparatus that function with computer system 1000 for edge directed image processing may include, but are not limited to, a TV or HDTV, a DVD, HD DVD, or BD player or a player application for another optically encoded medium, a player application for an encoded magnetic, solid state (e.g., flash memory) or other storage medium, an audio/visual (A/V) receiver, a media server (e.g., a centralized personal media server), a medical, scientific or other imaging system, professional video editing and/or processing systems, a workstation, desktop, laptop, hand-held or other computer, a network element, a network capable communication and/or computing device such as a cellular telephone, portable digital assistant (PDA), portable entertainment device, portable gaming device, or the like. One or more of the features of computer system 1000 may be implemented with an integrated circuit (IC) device, configured for executing the features. The IC may be an application specific IC (ASIC) and/or a programmable IC device such as a field programmable gate array (FPGA) or a microcontroller.

### EXAMPLES

In an embodiment, a method comprises or a computer-readable medium carrying one or more sequences of instructions, which instructions, when executed by one or more processors, cause the one or more processors to carry out the steps of: accessing information that relates to an edge feature of an input image that has an input resolution value, wherein the information relates a plurality of pixels of the input image to the input image edge feature and includes, for input pixels that comprise a component of the edge feature, an angle value corresponding to the edge feature and wherein the edge feature has a profile characteristic in the input image, registering an output image at an output resolution value to the input image, based on the registering step, associating the accessed edge feature related information with output pixels, wherein the associated information designates at least some of the output pixels as registered with the input image edge feature and the corresponding edge angle value, based on the edge angle value, selecting the edge component input pixels, and processing the selected edge component input pixels, wherein the step of processing the selected edge component input pixels deters deterioration of the profile characteristic of the edge feature in the output image.

In an embodiment, a method or computer-readable medium further comprises wherein the output image has a resolution that equals or differs from the input image resolution.

In an embodiment, a method or computer-readable medium wherein processing the video image comprises performing a noise reduction operation on the video image based on the processing step.

In an embodiment, a method or computer-readable medium further comprises wherein, for an output image that has an output resolution equal to the input resolution, the processing the selected edge component input pixels step comprises the step of filtering the selected edge component input pixels with a low pass filter.

In an embodiment, a method or computer-readable medium further comprises wherein an output resolution that differs from the input resolution is greater or less than the input resolution.

In an embodiment, a method or computer-readable medium further comprises wherein the processing the selected edge component input pixels step comprises: applying interpolation filtering to the selected edge component input pixels, and generating an output pixel based on the interpolation filtering applied to the generated pixels.

In an embodiment, a method or computer-readable medium further comprises wherein the processing the selected edge component input pixels step comprises: performing interpolation filtering on one or more groups of the selected edge component input pixels, wherein the performed interpolation filtering generates pixels at locations in the output image that conform to the edge angle value, applying interpolation filtering to the generated pixels, and generating an output pixel based on the interpolation filtering applied to the generated pixels.

In an embodiment, a method or computer-readable medium further comprises wherein processing the video image comprises performing a scaling operation on the video image based on the filtering process.

In an embodiment, a method or computer-readable medium further comprises wherein the scaling operation comprises at least one of an upconversion or a downconversion operation.

In an embodiment, a method or computer-readable medium further comprises wherein the profile characteristic comprises at least one of a shape, a sharpness, a contour or a definition attribute that relates to the edge feature.

In an embodiment, a method or computer-readable medium further comprises wherein the step of processing the selected edge component input pixels comprises a filtering step that is performed independently of a scaling procedure.

In an embodiment, a method or computer-readable medium further comprises wherein the scaling procedure comprises one or more of horizontal or vertical filtering.

In an embodiment, a method or computer-readable medium further comprises applying the scaling procedure to input pixels that are free of an edge feature, and generating one or more output pixels that are free from the output edge feature, based at least in part on the applying the scaling feature step.

In an embodiment, a system comprises means for accessing information that relates to an edge feature of an input image that has an input resolution value, wherein the information relates a plurality of pixels of the input image to the input image edge feature and includes, for input pixels that comprise a component of the edge feature, an angle value corresponding to the edge feature and wherein the edge feature has a profile characteristic in the input image, means for registering an output image at an output resolution value to the input image; means for associating the accessed edge feature related information with output pixels based on a function of the registering means, wherein the associated information designates at least some of the output pixels as registered with the input image edge feature and the corresponding edge angle value, means for selecting the edge component input pixels based on the edge angle value, and means for processing the selected edge component input pixels; wherein the means for processing the selected edge component input pixels functions to deter deterioration of the profile characteristic of the edge feature in the output image. In an embodiment, a method comprises or a computer-readable medium carrying one or more sequences of instructions, which instructions, when executed by one or more processors, cause the one or more processors to carry out the steps of: accessing information that relates to an edge feature of an input image that has an input resolution value, wherein the information relates a plurality of pixels of the input image to the input image edge feature and includes, for input pixels that comprise a component of the edge feature, an angle value corresponding to the edge feature and wherein the edge feature has a profile characteristic in the input image, registering an output image at an output resolution value to the input image, based on the registering step, associating the accessed edge feature related information with output pixels, wherein the associated information designates at least some of the output pixels as registered with the input image edge feature and the corresponding edge angle value, based on the edge angle value, selecting the edge component input pixels, and processing the selected edge component input pixels, wherein the step of processing the selected edge component input pixels deters deterioration of the profile characteristic of the edge feature in the output image.

### Equivalents, Extensions, Alternatives And Miscellaneous

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method for processing a video image, comprising the steps of:
accessing information that relates to an edge feature of an input image that has an input resolution value;
wherein the information relates a plurality of pixels of the input image to the input image edge feature and includes, for input pixels that comprise a component of the edge feature, an angle value corresponding to the edge feature and wherein the edge feature has a profile characteristic in the input image;
registering an output image at an output resolution value to the input image;
based on the registering step, associating the accessed edge feature related information with output pixels;
wherein the associated information designates at least some of the output pixels as registered with the input image edge feature and the corresponding edge angle value;
based on the edge angle value, selecting the edge component input pixels; and
processing the selected edge component input pixels;
wherein the step of processing the selected edge component input pixels deters deterioration of the profile characteristic of the edge feature in the output image.

2. The method as recited in claim 1 wherein the output image has a resolution that equals or differs from the input image resolution.

3. The method as recited in claim 2 wherein processing the video image comprises performing a noise reduction operation on the video image based on the processing step.

4. The method as recited in claim 3 wherein, for an output image that has an output resolution equal to the input resolution, the processing the selected edge component input pixels step comprises the step of filtering the selected edge component input pixels with a low pass filter.

5. The method as recited in claim 2 wherein an output resolution that differs from the input resolution is greater or less than the input resolution.

6. The method as recited in claim 5 wherein the processing the selected edge component input pixels step comprises the steps of:
applying interpolation filtering to the selected edge component input pixels; and
generating an output pixel based on the interpolation filtering applied to the generated pixels.

7. The method as recited in claim 5 wherein the processing the selected edge component input pixels step comprises the steps of:
performing interpolation filtering on one or more groups of the selected edge component input pixels;
wherein the performed interpolation filtering generates pixels at locations in the output image that conform to the edge angle value;
applying interpolation filtering to the generated pixels; and
generating an output pixel based on the interpolation filtering applied to the generated pixels.

8. The method as recited in one or more of claim 6 wherein processing the video image comprises performing a scaling operation on the video image based on the filtering process.

9. The method as recited in claim 8 wherein the scaling operation comprises at least one of an upconversion or a downconversion operation.

10. The method as recited in claim 1 wherein the profile characteristic comprises at least one of a shape, a sharpness, a contour or a definition attribute that relates to the edge feature.

11. The method as recited in claim 1 wherein the step of processing the selected edge component input pixels comprises a filtering step that is performed independently of a scaling procedure.

12. The method as recited in claim 11 wherein the scaling procedure comprises one or more of horizontal or vertical filtering.

13. The method as recited in claim 12 wherein, further comprising the steps of:
applying the scaling procedure to input pixels that are free of an edge feature; and
generating one or more output pixels that are free from the output edge feature, based at least in part on the applying the scaling feature step.

14. A video image processing system, comprising:
means for accessing information that relates to an edge feature of an input image that has an input resolution value;
wherein the information relates a plurality of pixels of the input image to the input image edge feature and includes, for input pixels that comprise a component of the edge feature, an angle value corresponding to the edge feature and wherein the edge feature has a profile characteristic in the input image;
means for registering an output image at an output resolution value to the input image;
means for associating the accessed edge feature related information with output pixels based on a function of the registering means;
wherein the associated information designates at least some of the output pixels as registered with the input image edge feature and the corresponding edge angle value;
means for selecting the edge component input pixels based on the edge angle value; and
means for processing the selected edge component input pixels;
wherein the means for processing the selected edge component input pixels functions to deter deterioration of the profile characteristic of the edge feature in the output image.

15. A computer readable storage medium having encoded instructions which, when executed by one or more processors, cause the one or more processors to perform a method for processing a video image, the method comprising the steps of:
accessing information that relates to an edge feature of an input image that has an input resolution value;
wherein the information relates a plurality of pixels of the input image to the input image edge feature and includes, for input pixels that comprise a component of the edge feature, an angle value corresponding to the edge feature and wherein the edge feature has a profile characteristic in the input image;
registering an output image at an output resolution value to the input image;
based on the registering step, associating the accessed edge feature related information with output pixels;
wherein the associated information designates at least some of the output pixels as registered with the input image edge feature and the corresponding edge angle value;
based on the edge angle value, selecting the edge component input pixels; and
processing the selected edge component input pixels;
wherein the step of processing the selected edge component input pixels deters deterioration of the profile characteristic of the edge feature in the output image.

16. The method as recited in one or more of claim 7 wherein processing the video image comprises performing a scaling operation on the video image based on the filtering process.

17. The method as recited in claim 16 wherein the scaling operation comprises at least one of an upconversion or a downconversion operation.
